(19) United States
(12) Patent Application Publication
(10) Pub. No.: US 2019/0184954 A1
(43) Pub. Date: Jun. 20, 2019

(54) PNEUMATIC BRAKING SYSTEM

(71) Applicant: Adolf KOCHSIEK, Leopoldshöhe (DE)

(72) Inventor: Adolf KOCHSIEK, Leopoldshöhe (DE)

(21) Appl. No.: 16/310,651

(22) PCT Filed: Jun. 23, 2017
(86) PCT No.: PCT/EP2017/065485

§ 371 Date: Dec. 17, 2018

(30) Foreign Application Priority Data
Jun. 23, 2016 (EP) 16175893.3

(51) Int. Cl. B60T 13/36; B60T 13/66; B60T 13/68; B60T 17/02; B60T 17/04

(52) U.S. Cl. CPC B60T 13/36; B60T 13/662; B60T 17/04; B60T 17/02; B60T 13/683

(57) ABSTRACT

The disclosure relates to a brake system for vehicles, comprising a brake unit. In order to provide a new brake system, which is in particular more lightweight and more environmentally friendly, a brake unit is proposed which comprises at least a brake disc and a brake piston unit, a compressed air reservoir, and a control unit in order to pressurise the brake piston unit with compressed air from the compressed air reservoir on demand.

### CROSS-REFERENCE TO RELATED APPLICATIONS

This application is a National Stage of International Application No. PCT/EP2017/065485, filed on Jun. 23, 2017. This application claims the priority to European Patent Application No. 16175893.3, filed on Jun. 23, 2016. The entire disclosures of the above applications are incorporated herein by reference.

### FIELD

The present disclosure relates to a brake system for vehicles.

### BACKGROUND

This section provides background information related to the present disclosure which is not necessarily prior art.

Brake systems have been extensively known and are in use. In the area of motorcars, hydraulic brake systems have become generally accepted. In these systems, a brake fluid is fed under pressure from a reservoir to the brake shoes and causes the brake shoes to move in the direction of a brake disc. These systems have a number of disadvantages. An essential disadvantage is the necessity to produce, store, and use a separate medium, the brake fluid. It has hygroscopic properties and therefore needs to be replaced at regular intervals. The reservoir, the brake master cylinder, the lines and valves are heavy systems. As a whole, a hydraulic brake system is heavy.

In the field of trucks, pneumatic brake systems are perfectly well known; in these, however, only a power-operated piston exerts pressure on a charged system. It is not actually a pneumatic system, as it is not comparable with it, but rather constitutes a pneumatic boosting.

Hydraulic brake systems are essentially perfected. They are hardly modifiable, and in particular in relation to new vehicle developments, they cannot be adjusted very well. New vehicle developments, as for instance hybrid vehicles or electric vehicles, require different braking times and braking moments. Electric motors are practically switched on and off, i.e. moments acting on wheels are spontaneous and therefore need to be correspondingly reactive. Moreover, there is a fundamental need to save weight in vehicles wherever possible, in order to optimise consumption in relation to an appropriate performance. In particular in electric vehicles, the additional weight of the battery needs to be compensated for.

### SUMMARY

This section provides a general summary of the disclosure, and is not a comprehensive disclosure of its full scope or all of its features.

Starting from the prior art described above, the disclosure is based on the object to provide a new brake system which is in particular more lightweight and more environmentally friendly and, moreover, more flexible in relation to further developments and adjustments to advanced vehicle systems.

For the technical solution of this object, a brake system with the features of patent claim 1 is proposed. Other advantages and features result from the sub-claims.

For the technical solution, a brake system for vehicles is proposed which comprises a brake unit consisting of a brake disc and a brake piston unit, wherein an air accumulator filled with compressed air is discharged by a control unit in such a way that compressed air is supplied to pressurise the brake piston unit as required.

The supply as required depends on a signal generator which can be a pedal or any switch in a conventional way. The indication of the brake pressure requirement may be purely digital and electronic and does not need to be exercised with physical strength any more. As a result, the system is particularly suitable also for the handicapped or for entirely different alternative actuating operations.

The system according to the disclosure is distinguished by special leak tightness of the individual units and good controllability. Moreover, it is not susceptible to leakage, and in particular in the event of a leak, it does not lead to environmental damage.

The pneumatic system is cheaper and it is particularly more suitable for new, electric driving systems.

Of course the brake system according to the disclosure comprises a brake piston unit which is arranged in the area of e.g. a brake disc, which brake piston unit can be pressurised with compressed air via a valve triggered by a control unit, using corresponding lines. The compressed air comes from one or several reservoirs which are also connected with the corresponding valve or the control unit, respectively, by means of lines. An actuating unit may initiate a braking process either directly via the valves or indirectly, and for instance also digitally, via the control unit. This actuating unit may be anything from a conventional pedal to a joystick-like brake control. Any kind of actuating unit is imaginable.

A great advantage of the system results from using low pressures of less than 25 bar. For correspondingly large-area pistons which, according to an advantageous proposal of the disclosure, have been manufactured out of round and may therefore have e.g. an elliptic cross section, these pressures are sufficient. With corresponding non-circular contours, large piston areas may be used in order to achieve correspondingly good braking results without the requirement for more total installation space.

Reservoirs are provided multi-redundantly. According to the disclosure, at least one reservoir will be provided as an emergency reservoir. According to another advantageous proposal, an emergency reservoir will be provided for each wheel. This provides more safety regarding the applicability of the system and extends the usability thereof.

Safety is further enhanced by the use of multi-circuit systems. According to a particularly advantageous proposal of the disclosure, a four-circuit system may be used. It is also imaginable to use the latter for instance in the sense of a cross connection in order to couple a circuit for one wheel with the circuit of another wheel in the case of failure.

The system according to the disclosure carries a great number of advantages. First of all, in the case of a leak, it is not harmful to the environment. In addition, since only compressed air needs to be supplied, it can basically be refilled at any time. At least a minimum of functionality can be maintained. Brake fluid can be dispensed with completely, in particular also the frequent change of it, which accounts for a huge quantity in view of the large number of vehicles. Moreover, a lot of weight can be saved, as brake servos and similar additional units can also be dispensed with completely. When using large brake pistons, which can be produced by means of new technologies such as non-circular technique, it is possible to work with low pressures. As air is compressible on principle, which is basically not the case with hydraulics, also this factor can be taken into account when using large pistons. With the system according to the disclosure, the brake pistons are always actuated directly, and not indirectly via any intermediate units. The piston acts directly on the brake shoe, and therefore as a brake. Moreover, in comparison to conventional systems, the pneumatic system is extremely fast.

For generating pressure, also examples have been known which are based on the proposal to accommodate a wind generator on a car in an area in an air flow to generate electrical energy.

A system is proposed in which a wind turbine, a compressor, or a compressed air reservoir act in combination. The wind turbine is driven by the relative movement of the vehicle through the surrounding air. The air in turn drives a compressor which fills the compressed air reservoir.

A compressor as defined by the present disclosure is a kind of air compressor, so the turbine may also comprise a simple compressor stage.

In an advantageous manner, the wind turbine may be a radial impeller to which dynamic pressure is applied.

According to another advantageous proposal of the disclosure, the wind turbine may alternatively be driven mechanically. In this manner, it is possible to charge the compressed air reservoir even while at a standstill. For this purpose, for instance an electric motor, a combustion engine, or the like may be used.

According to another advantageous proposal of the disclosure, a multi-stage storage unit may be considered as a compressed air reservoir. In this manner, several compressed air reservoirs may be charged in parallel in order to be available as redundant compressed air sources. These compressed air reservoirs may for instance be arranged in the front area of a passenger compartment, thereby even providing a safety buffer.

The disclosure provides a novel brake system for vehicles which can be actuated by compressed air and eliminates the disadvantages of hydraulic and mechanical systems.

### DRAWINGS

The drawings described herein are for illustrative purposes only of selected embodiments and not all possible implementations, and are not intended to limit the scope of the present disclosure.

Other advantages and features of the disclosure can be gathered from the following description on the basis of the figures. In these figures:

FIG. 1 shows a schematic representation of an exemplary embodiment of a brake system according to the disclosure.

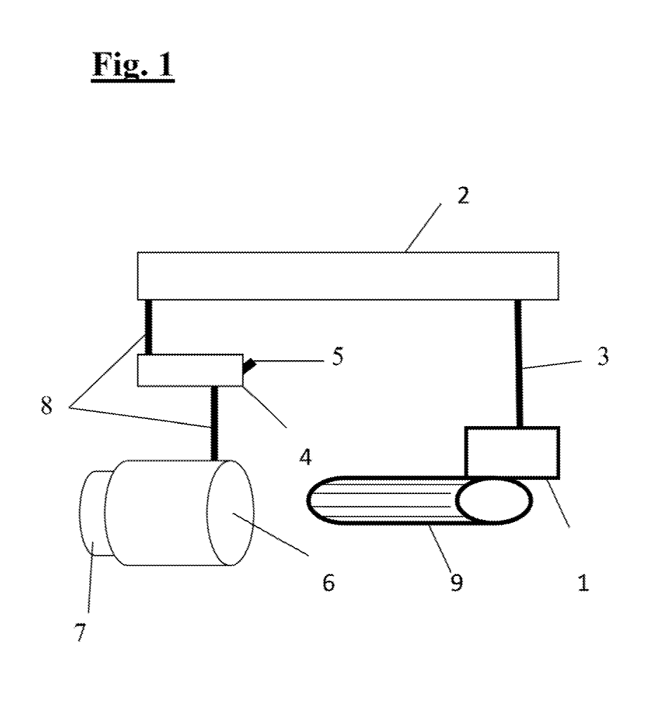

Corresponding reference numerals indicate corresponding parts throughout the drawing.

### DETAILED DESCRIPTION

Example embodiments will now be described more fully with reference to the accompanying drawing.

Purely schematically, a compressor or a compressed air source 1 is shown which fills a compressed air reservoir 2. For this purpose, the compressed air source 1 is connected to the reservoir by means of corresponding lines 3. A control unit 4 which, in the exemplary embodiment shown, can be actuated by means of a directly connected actuating member 5, can feed compressed air via the lines 8 from reservoir 2 to a cylinder 6, in which a piston 7 is guided. This may be the brake piston, which directly actuates a brake shoe. The brake shoe then acts on a disc of a vehicle, which disc is not shown here.

The exemplary embodiment shown also shows a generator 9 stylised as a radial impeller. The radial impeller may for instance be arranged in the dynamic pressure area of a vehicle and operate the compressed air source 1 designed as a compressor.

The described exemplary embodiment only serves a better understanding and is not restrictive.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A brake system for vehicles, comprising a brake unit which comprises at least one brake disc and a brake piston unit, a compressed air reservoir, an actuating unit, and a control unit in order to pressurise the brake piston unit with compressed air from the compressed air reservoir on demand.

2. The brake system according to claim 1, wherein the compressed air reservoir provides air with a pressure of less than 25 bar.

3. The brake system according to claim 1, wherein the brake system comprises several compressed air reservoirs.

4. The brake system according to claim 1, wherein the brake system comprises an emergency compressed air reservoir.

5. The brake system according to claim 4, wherein an emergency compressed air reservoir is provided for each wheel.

6. The brake system according to claim 1, wherein the brake system is designed as a multi-circuit system.

7. The brake system according to claim 6, wherein the brake system is designed as a four-circuit system.

8. The brake system according to claim 1, wherein the actuating unit can be operated manually.

9. The brake system according to claim 1, wherein the brake piston unit comprises a piston with a non-circular cross section.

10. The brake system according to claim 9, wherein the brake piston unit comprises a piston with an elliptical piston area.
